(19) United States
(12) Patent Application Publication
(10) Pub. No.: US 2005/0107906 A1
(43) Pub. Date: May 19, 2005

(54) Device for reproduction of patterns on a support

(76) Inventor: Franck Maurence, Torreilles (FR)

Correspondence Address: HARRISON & EGBERT, 412 MAIN STREET, 7TH FLOOR, HOUSTON, TX, 77002, US

(21) Appl. No.: 10/489,089

(22) PCT Filed: Sep. 17, 2002
(86) PCT No.: PCT/FR02/03179

(30) Foreign Application Priority Data
Sep. 17, 2001 (FR) 01 12003

(51) Int. Cl. G06F 19/00

(52) U.S. Cl. 700/161; 428/195.1

(57) ABSTRACT

The invention concerns a device for the reproduction of pictures on supports, in particular large-size supports of various shapes, adapted to implement the method which consists in selecting a specific viewpoint of the support, in framing and capturing the image of said specific viewpoint, in still reading said image of the picture to be reproduced, in transmitting the resulting new image to an operator positioned at said support so that he reproduces the picture on said support with a tracing instrument and using the new image wherein he sees himself drawing. The device comprises means (5) for processing the image adapted to breaking down said new image into fractions, so as to transmit to said operator, at the latter's request, via display means (4), only the enlarged fraction of the new image wherein said operator is.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to a device for the reproduction of drawings on supports, in particular of large-size supports of various shapes, such as frontages, monuments, or natural sites.

### BACKGROUND OF THE INVENTION

The purpose of the present invention is in particular to provide a device for the implementation of the process described in FR 2,660,598 in the name of the present Applicant. In this document is described a process for assisting the reproduction of images implementing primarily a video-camera and a monitor. According to this process, the camera is placed so as to film the support aimed at receiving the reproduction of an object, the filmed image is transmitted to the monitor, while the image of the object to be reproduced is still read into said filmed image. The operator has marking means and a monitor, he can thus trace on the support the contours of the object while controlling in real time on said monitor the displacement of said tracing means.

Though this process has many advantages over the former techniques for the reproduction of drawings, it has however disadvantages, namely as regards its implementation, since it requires that the operator moves with the monitor, which is particularly cumbersome.

Furthermore, such implementation means do not allow the reproduction of drawings on very large-size supports of complex shapes. It is indeed not possible to accurately reproduce some details of the drawing, because of the size of the image, so that the reproduction is only approximate.

### BRIEF SUMMARY OF THE INVENTION

The purpose of the present invention is to propose a device for the reproduction of drawings on supports, in particular large-size supports of various shapes, such as frontages, monuments, or natural sites implementing the above-mentioned process and allowing to cope with the various above-mentioned disadvantages.

The device for the reproduction of drawings on supports, in particular large-size supports of various shapes such as frontages monuments or natural sites, according to the invention is of the type capable of implementing the process consisting in selecting a specific viewpoint of the support, in framing and capturing the image of said specific viewpoint, in still reading into said image the drawing to be reproduced, in transmitting the new image thus obtained to an operator positioned at the level of said support, so that he reproduces the drawing on said support by means of a tracing tool and making use of said new image where he sees himself drawing in real time, and it is primarily characterized in that it includes means for processing the image capable of breaking down said new image, in order to transmit to said operator, at the latter's request, through displaying means, only the enlarged portion of the new image in which said operator is.

According to an additional feature of the process according to the invention, it comprises means for capturing the image consisting of a video-camera or digital camera.

According to another feature of the device according to the invention, it includes means for transmitting data from the image-processing means to the display means, which consists of a radio-waves transmitting/receiving unit.

According to another feature of the device according to the invention, the means for displaying the new image consists of a pair of audio/video glasses.

According to a particularly advantageous feature of said device, the tracing tool includes means for transmitting its position allowing the image-processing means to locate its displacement on the new image and, hence, on the support, so as to allow, in association with comparing means, to transmit to the operator different signals according to whether said tracing tool is located or not in front of the plotting to be performed.

According to a particular embodiment, the operator is a robot capable of moving along the surface of the support so as to have it scanned by the tracing tool.

According to another additional feature of the device according to the invention, the tracing tool consists of a paint gun comprising a microvalve.

The advantages and features of the device according to the invention will become clear from the following description, which refers to the attached drawing, which represents a non-restrictive embodiment of same.

### BRIEF DESCRIPTION OF THE SEVERAL VIEWS OF THE DRAWINGS

In the attached drawing:

FIG. 1 shows a schematic view of a device according to the invention.

FIG. 2 shows a schematic view of various phases of use of the device according to the invention.

### DETAILED DESCRIPTION OF THE INVENTION

The device according to the invention is aimed at reproducing patterns, such as, for example, advertisement images, on large-size supports, these patterns being in general made with paint. In particular, the invention allows to carry out anamorphoses and this irrespective of the characteristics of the support.

To this end, the operator starts by selecting the optimal viewpoint of the support S on which he has to paint. In the example shown, the support consists of a water tower, while the drawing D to be reproduced consists of a side view of a face.

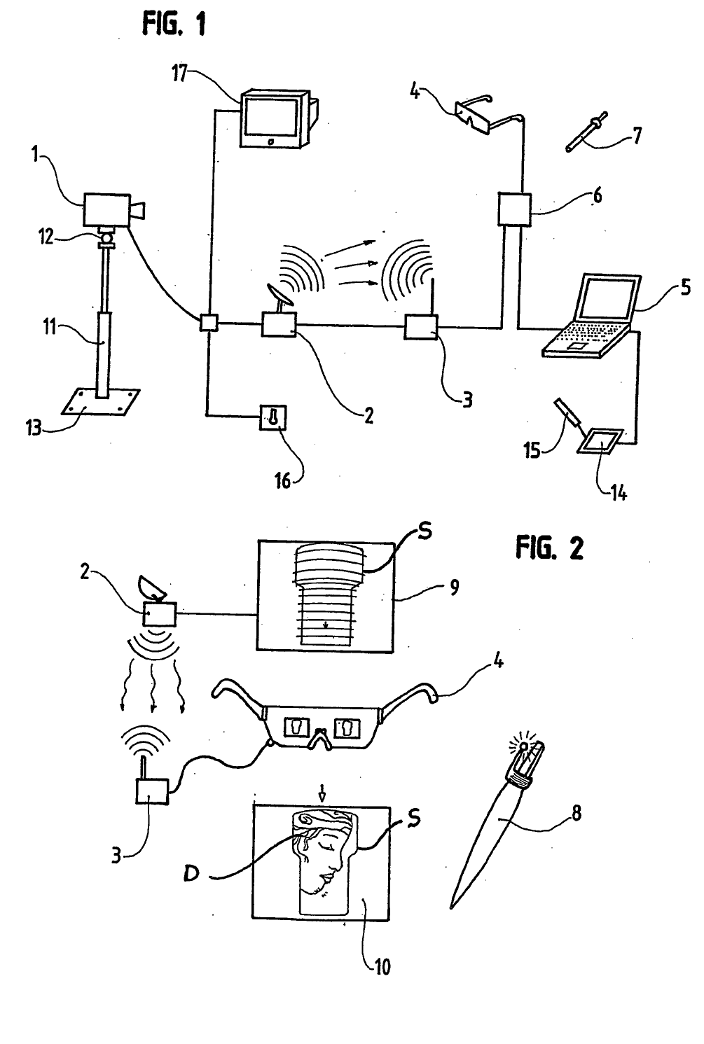

As can be seen in FIG. 1, the device according to the invention comprises a apparatus for framing an image, such as a camera 1, which is preferably fixed to the floor by means of an irremovable base 13, which allows the viewpoint not to vary, whether the result of the implementation is final or transitory.

The camera 1 can furthermore, according to the need of the framework, be installed on a telescopic stand 11, through an adjustable and, preferably, remote-controlled knee joint 12. In this way, it is possible to achieve the best possible framing of the support S, starting from a predetermined place.

The camera 1 itself is connected to means for transmission the filmed data, which consists, in this case, of a radio-wave transmitter/receiver 3.

It should be noted that it could, of course, be a transmission by cable, but the latter however provides less freedom to the operator than the transmission by radio waves.

Preferably, the transmitter 2 used will have a range of at least 100 to 150 m, while the receiver 3 is designed capable of being carried by the operator.

The data regarding the framed image are transmitted onto a preferably light and portable display screen, such as, in the example shown, audio/video glasses 4 of the type as used in the field of multimedia, the operator wears during the carrying out of the drawing D on the support S.

The device according to the invention comprises means allowing to still read the drawing D on the image framed by the camera I, and which consists of a computer 5 having image-processing means, such as software, and connected to, or integrating an overprinting casing 6.

Once the still reading has been carried out, the new image is transmitted to the glasses 4 that the operator carries, and the latter then displays the new image of the support and the still read drawing D.

He thus sees the support, the still read drawing D on the support S, and its own person appearing simultaneously on the display screen.

He can thus move along the support and see himself moving in the glasses 4. In order to reproduce said pattern, it is then enough for him to follow the contours of the latter as they appear on said display screen, and since they appear in a sufficiently accurate way, using a tracing tool 8, such as for example a brush or a paint aerosol.

The tracing tool 8 can eventually be positioned in a sheath 7 especially machined for this purpose and providing more handiness for the user.

As regards the drawing D to be still read, it can proceed from a drawing library or be created by the operator himself, for example, by means of a graphic board 14 and a pen 15, which graphic board is connected to the computer 5, or also by digitizing a work already made previously and available on paper.

FIG. 2 schematically shows various phases of use of the device according to the invention. Thus, one sees an image 9 of the water tower as framed by the camera 1. Then the face to be reproduced is still read on image 9, so as to obtain a new image 10 which appears on the glasses 4, the data being transmitted via the transmitter 2 and the receiver 3.

The painter can then trace the contour of the drawing D being assisted by what he sees in real time in the glasses.

In the case of a support S and a large-size drawing D, the new image appears very small on the display screen, which the glasses 4 are, so that it is difficult for the operator to trace an exact contour. Therefore, according to the invention, the device includes image-processing means allowing to break up the new image and to transmit onto the display screen and, hence, to the operator, only a fraction of this new image.

The operator is of course capable of choosing the fraction of the new image which he wants to see appearing on the display screen, it is also possible for him, to eventually obtain an enlarged view of this fraction and, of course, an overall view in order to observe the progress of the work.

In an advantageous way, the operator gives instructions to the computer 5 with his voice through vocal control.

Furthermore, the device according to the invention allows several operators to work simultaneously without disturbing each other, each one working oil a fraction of the new image and being able at any time to see the work made by his colleague or colleagues.

According to a particular embodiment, the tracing tool 8 includes means allowing it to transmit a signal allowing the computer 5 to locate its position with respect to the support S, so that the computer can, through processing means, determine whether the position of the tracing tool is or not in front of the contour to be traced and, as the case may be, a signal is sent to the operator, in order to validate or not the position of the tracing tool.

The computer can indeed compare the initial image and the new image, and determine from same the pixels that are modified to pass over from one image to the other one and, when the location of the tracing tool is marked in the new image, it is easy to determine whether this position corresponds to modified pixels.

This peculiarity of the device according to the invention allows to carry out the work with very high accuracy and thus to perfectly stick to the model.

This also allows to automatically control the tracing, for example when the latter is carried out by means of a paint jet on the support S.

This configuration allows to contemplate the automation of the tracing, i.e. to replace the operator by a robot.

Indeed, it is presently difficult to imagine programming robot so that it carries out the tracing of the contours of the drawing D on the support S, this operation would indeed be time-consuming and tiresome, whereby one should know that the result is sometimes expected to be transitory.

With the device according to the invention, it is possible to use a robot of a simple design capable of causing the surface of the support S to be scanned by the tracing tool 8, preferably at a relatively constant distance from the latter determined by detecting means, so that a paint jet or the like is delivered when the tracing tool 8 is in front of the contour of the drawing D to be reproduced.

Advantageously, such a robot requires only little programming, in addition to that of the outer limits of its evolution.

1. Device for reproduction of drawings on supports, in particular large-size supports of various shapes, such as frontages, monuments, or natural sites, said device implementing a process comprised of selecting a specific viewpoint of the support, framing and capturing the image of said specific viewpoint, still reading into said image the drawing to be reproduced, transmitting the new image thus obtained to an operator positioned at the level of said support, so that said operator reproduces the drawing on said support by a tracing and making use of said new image where said operator sees said operator drawing in real time, said device comprising:
means for processing the image by breaking down said new image, in order to transmit to said operator, at the latter's request, through displaying means, only the enlarged portion of the new image in which said operator is.

2. Device according to claim 1, further comprising: means for capturing the image being comprised of a video-camera or digital camera.

3. Device according to claim 1, further comprising: means for transmitting data from an image-processing means to a display means, said means for transmitting being comprised of a radio-wave transmitting/receiving unit.

4. Device according to claim 1, wherein the means for displaying the new image is comprised of a pair of audio/video glasses.

5. Device according to claim 1, wherein said tracing tool is comprised of a paint gun comprising a microvalve.

6. Device according to claim 1, wherein said tracing tool further comprises: means for transmitting position of said tracing tool, allowing the image-processing means to locate displacement on the new image and on the support, so as to allow, in association with comparing means, to transmit to the operator different signals according to whether said tracing tool is located or not in front of the plotting to be performed.

7. Device according to claim 6, wherein said operator is a robot moving along the surface of the support so as to cause the latter to be scanned by the tracing tool.
